(19) United States
(12) Patent Application Publication
(10) Pub. No.: US 2024/0381148 A1
(43) Pub. Date: Nov. 14, 2024

(54) CHANNEL STATE INFORMATION INTERFERENCE MEASUREMENT RESOURCES FOR FULL-DUPLEX SETS OF SYMBOLS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 18/411,587

(22) Filed: Jan. 12, 2024

Related U.S. Application Data
(60) Provisional application No. 63/501,283, filed on May 10, 2023.

(51) Int. Cl. H04W 24/10; H04L 5/16

(52) U.S. Cl. CPC H04W 24/10; H04L 5/16

(57) ABSTRACT

Various aspects of the present disclosure generally relate to wireless communication. In some aspects, a user equipment (UE) may receive configuration information indicating one or more channel state information (CSI) report configurations that configure one or more CSI interference measurement (CSI-IM) resources, including a CSI-IM resource associated with a full-duplex (FD) set of symbols and a CSI-IM resource associated with a half-duplex (HD) set of symbols. The UE may perform interference measurements associated with at least one of the FD set of symbols, using the CSI-IM resource associated with the FD set of symbols, or the HD set of symbols, using the CSI-IM resource associated with the HD set of symbols. The UE may transmit one or more CSI reports reporting the interference measurements associated with the at least one of the FD set of symbols or the HD set of symbols. Numerous other aspects are described.

### CROSS-REFERENCE TO RELATED APPLICATION

This Patent application claims priority to U.S. Provisional Patent Application No. 62/501,283, filed on May 10, 2023, entitled “CHANNEL STATE INFORMATION INTERFERENCE MEASUREMENT RESOURCES FOR FULL-DUPLEX SETS OF SYMBOLS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for channel state information interference measurement resources for full-duplex sets of symbols.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information indicating one or more channel state information (CSI) report configurations that configure one or more CSI interference measurement (CSI-IM) resources, the one or more CSI-IM resources including a CSI-IM resource associated with a full-duplex (FD) set of symbols and a CSI-IM resource associated with a half-duplex (HD) set of symbols. The method may include performing interference measurements associated with at least one of the FD set of symbols, using the CSI-IM resource associated with the FD set of symbols, or the HD set of symbols, using the CSI-IM resource associated with the HD set of symbols. The method may include transmitting one or more CSI reports reporting the interference measurements associated with the at least one of the FD set of symbols or the HD set of symbols.

Some aspects described herein relate to a method of wireless communication performed by a network node. The method may include transmitting, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols. The method may include receiving, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols.

Some aspects described herein relate to a UE for wireless communication. The UE may include one or more memories and one or more processors coupled to the one or more memories. The one or more processors may be configured to receive configuration information indicating one or more CSI report configurations that configure one or more CSI-IM resources, the one or more CSI-IM resources including a CSI-IM resource associated with an FD set of symbols and a CSI-IM resource associated with an HD set of symbols. The one or more processors may be configured to perform interference measurements associated with at least one of the FD set of symbols, using the CSI-IM resource associated with the FD set of symbols, or the HD set of symbols, using the CSI-IM resource associated with the HD set of symbols. The one or more processors may be configured to transmit one or more CSI reports reporting the interference measurements associated with the at least one of the FD set of symbols or the HD set of symbols.

Some aspects described herein relate to a network node for wireless communication. The network node may include one or more memories and one or more processors coupled to the one or more memories. The one or more processors may be configured to transmit, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols. The one or more processors may be configured to receive, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols.

Some aspects described herein relate to a non-transitory computer-readable medium that stores a set of instructions for wireless communication by a UE. The set of instructions, when executed by one or more processors of the UE, may cause the UE to receive configuration information indicating one or more CSI report configurations that configure one or more CSI-IM resources, the one or more CSI-IM resources including a CSI-IM resource associated with an FD set of symbols and a CSI-IM resource associated with an HD set of symbols. The set of instructions, when executed by one or more processors of the UE, may cause the UE to perform interference measurements associated with at least one of the FD set of symbols, using the CSI-IM resource associated with the FD set of symbols, or the HD set of symbols, using the CSI-IM resource associated with the HD set of symbols. The set of instructions, when executed by one or more processors of the UE, may cause the UE to transmit one or more CSI reports reporting the interference measurements associated with the at least one of the FD set of symbols or the HD set of symbols.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols. The set of instructions, when executed by one or more processors of the network node, may cause the network node to receive, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols.

Some aspects described herein relate to an apparatus for wireless communication. The apparatus may include means for receiving configuration information indicating one or more CSI report configurations that configure one or more CSI-IM resources, the one or more CSI-IM resources including a CSI-IM resource associated with an FD set of symbols and a CSI-IM resource associated with an HD set of symbols. The apparatus may include means for performing interference measurements associated with at least one of the FD set of symbols, using the CSI-IM resource associated with the FD set of symbols, or the HD set of symbols, using the CSI-IM resource associated with the HD set of symbols. The apparatus may include means for transmitting one or more CSI reports reporting the interference measurements associated with the at least one of the FD set of symbols or the HD set of symbols.

Some aspects described herein relate to an apparatus for wireless communication. The apparatus may include means for transmitting, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols. The apparatus may include means for receiving, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4C are diagrams illustrating examples of full duplex (FD) communication in accordance with the present disclosure.

FIG. 5 is a diagram illustrating examples of FD communication in a wireless network, in accordance with the present disclosure.

FIG. 6 is a diagram illustrating an example of a sub-band FD slot format, in accordance with the present disclosure.

FIG. 7 is a diagram illustrating an example of a channel state information (CSI) reporting setting, in accordance with the present disclosure.

FIG. 8 is a diagram of an example associated with CSI interference measurement resources for FD sets of symbols, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects relate generally to wireless communication and more particularly to configuration of channel state information (CSI) measurement resources for full-duplex (FD) sets of symbols. Some aspects more specifically relate to a CSI report setting that configures a user equipment (UE) with one or more CSI reference signals (CSI-RSs) for performing channel measurements in a half-duplex (HD) set of symbols and one or more CSI-RSs for performing channel measurements in an FD set of symbols (e.g., symbols associated with in-band FD (IBFD), sub-band FD (SBFD), or a similar set of symbols). In some examples, a UE may be configured with multiple CSI report settings for separately reporting channel measurements associated with the FD set of symbols and the HD set of symbols, and the multiple CSI report settings May be each associated with a separate CSI-RS resource or else the multiple CSI report settings may be associated with the same CSI-RS resource (e.g., different occasions of a periodic or semi-persistent CSI resources). In some other examples, a UE may be configured with a single CSI report setting for reporting channel measurements associated with both the FD set of symbols and the HD set of symbols, and the single CSI report setting may be associated with separate CSI-RS resources for FD measurements and HD measurements, or else the single CSI report setting may be associated with a same CSI-RS resource used for both FD measurements and HD measurements. In such examples, it may be desirable for the UE to also report interference measurements associated with the HD set of symbols and the FD set of symbols. However, there is currently no mechanism for configuring a UE to perform separate interference measurements for an HD set of symbols and an FD set of symbols. Moreover, while a channel may remain relatively stable within a slot containing both FD symbols and HD symbols, interference may significantly differ between such symbols due to cross-link interference (CLI) and other potential colliding transmissions within FD symbols. Thus, it may be desirable to configure resources for interference measurements in a way that is not constrained to a configuration of resources for channel measurement.

Some aspects described herein enable configuration of a UE with CSI interference measurement (CSI-IM) resources for performing interference measurements associated with FD sets of symbols and HD sets of symbols. In some examples, a configuration of one or more CSI-IM resources may follow a configuration of one or more CSI-RS resources, such as by configuring separate CSI-IM resources when separate CSI-RS resources are configured, or by configuring one CSI-IM resource with separate occasions used for FD interference measurements and HD interference measurements when one CSI-RS resource with separate occasions used for FD channel measurements and HD channel measurements is configured. In some aspects, one or more CSI-IM resources used for FD and HD interference measurements may be configured in a single slot having mixed symbol types, such as a slot including FD symbols (e.g., SBFD symbols) and HD symbols (e.g., non-SBFD symbols), and/or a CSI-IM resource may be associated with a CSI-IM pattern spanning multiple resource elements (REs) in time and/or frequency such that the CSI-IM resource spans both FD and HD symbols.

Particular aspects of the subject matter described in this disclosure can be implemented to realize one or more of the following potential advantages. By configuring a UE to report interference measurements associated with an FD set of symbols and an HD set of symbols, a network node may be provided with more relevant interference measurements associated with FD communication, and the network node may thus perform more improved selection of communication parameters, resulting in reduced communication errors, and thus reduced power, computing, and network resource consumption otherwise required for correcting communication errors. Moreover, by enabling configuration a UE with one more CSI-IM resources in a way that may not mirror a configuration of one or more CSI-RS resources used for channel measurement, a UE may be flexibly configured to perform and report varying levels of interference measurements in FD symbols and HD symbols, even when a channel is relatively static between the FD symbols and HD symbols.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

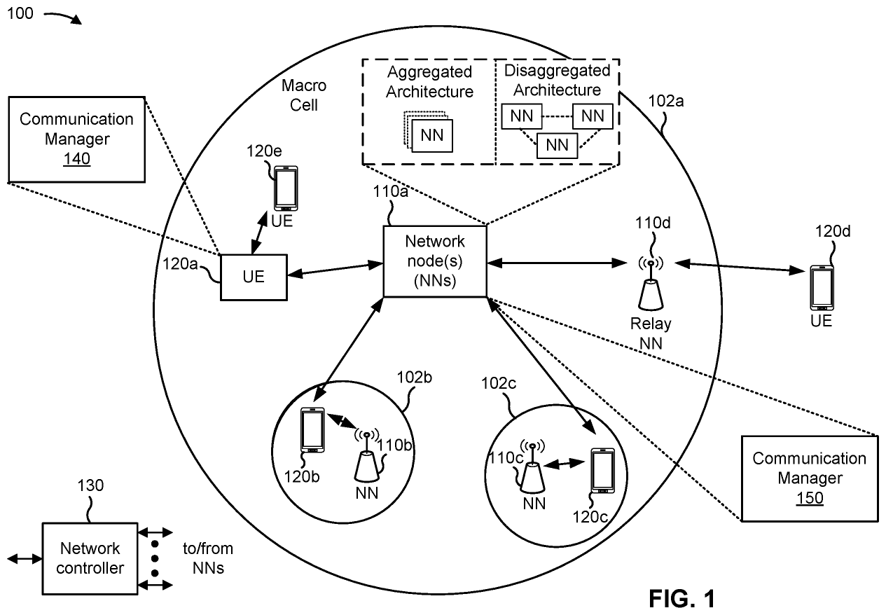

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information indicating one or more CSI report configurations that configure one or more CSI-IM resources, the one or more CSI-IM resources including a CSI-IM resource associated with an FD set of symbols and a CSI-IM resource associated with an HD set of symbols; perform interference measurements associated with at least one of the FD set of symbols, using the CSI-IM resource associated with the FD set of symbols, or the HD set of symbols, using the CSI-IM resource associated with the HD set of symbols; and transmit one or more CSI reports reporting the interference measurements associated with the at least one of the FD set of symbols or the HD set of symbols. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols; and receive, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols. Additionally, or alternatively, the communication manager 150 may perform one or more other operations described herein.

As indicated above, FIG. 1 is provided as an example. Other examples may differ from what is described with regard to FIG. 1.

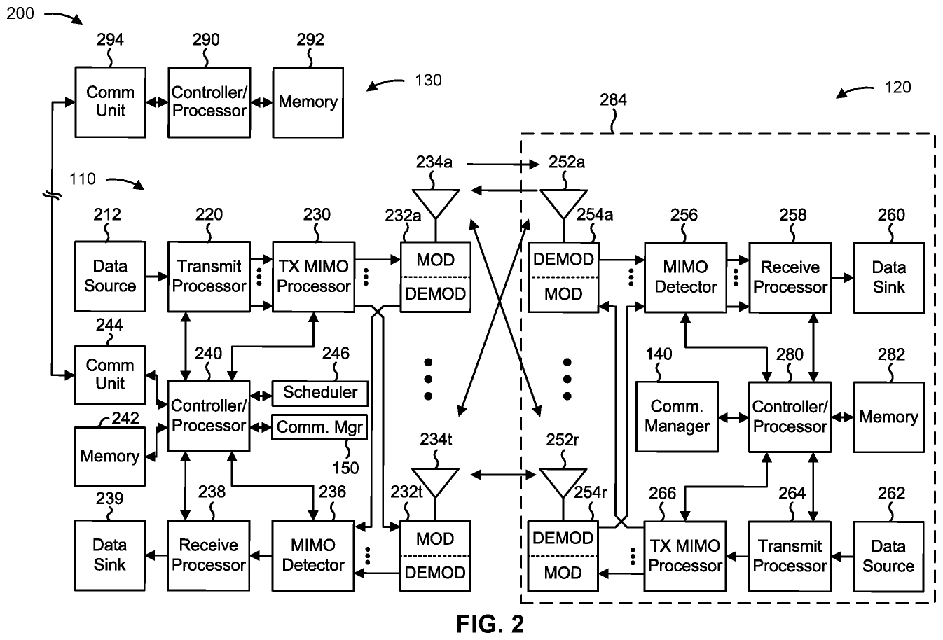

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

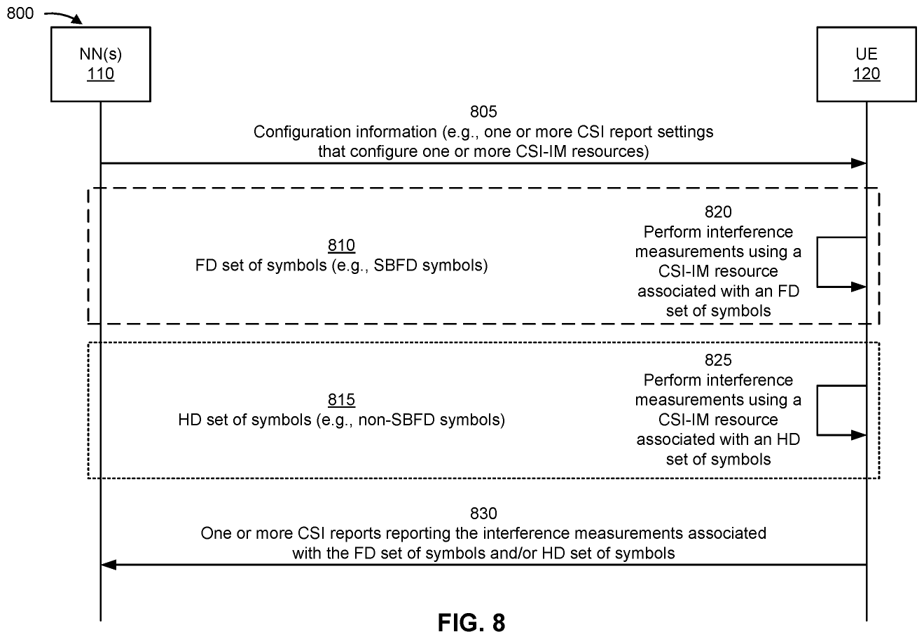

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

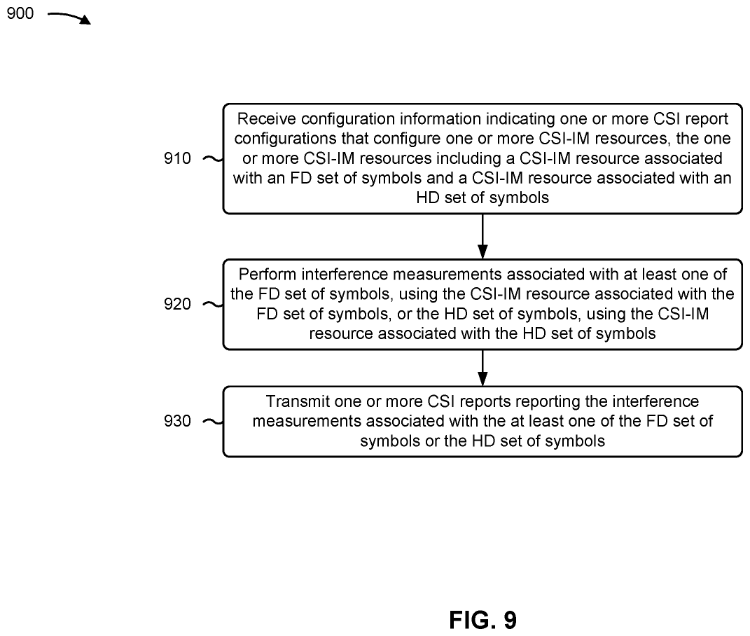

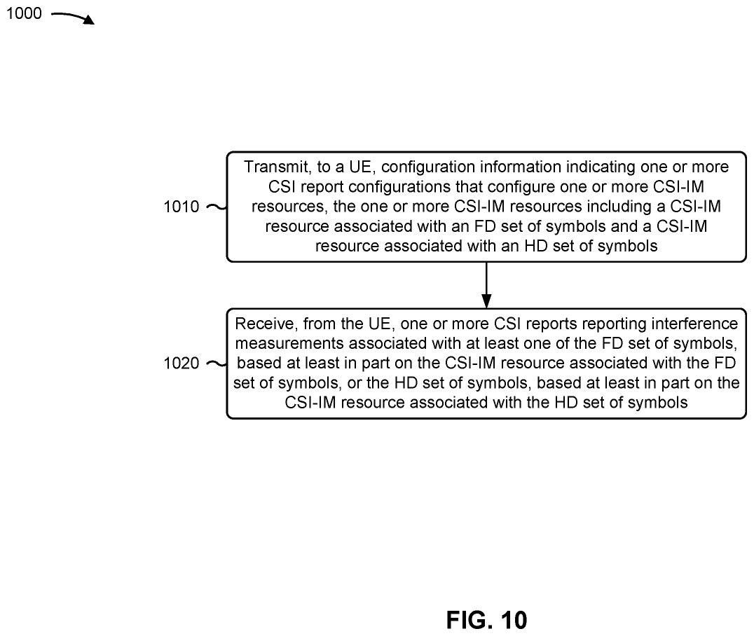

The controller/processor 240 of the network node 110, the controller/processor 280 of the UE 120, and/or any other component(s) of FIG. 2 may perform one or more techniques associated with CSI-IM resources for FD sets of symbols, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving configuration information indicating one or more CSI report configurations that configure one or more CSI-IM resources, the one or more CSI-IM resources including a CSI-IM resource associated with an FD set of symbols and a CSI-IM resource associated with an HD set of symbols; means for performing interference measurements associated with at least one of the FD set of symbols, using the CSI-IM resource associated with the FD set of symbols, or the HD set of symbols, using the CSI-IM resource associated with the HD set of symbols; and/or means for transmitting one or more CSI reports reporting the interference measurements associated with the at least one of the FD set of symbols or the HD set of symbols. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols; and/or means for receiving, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

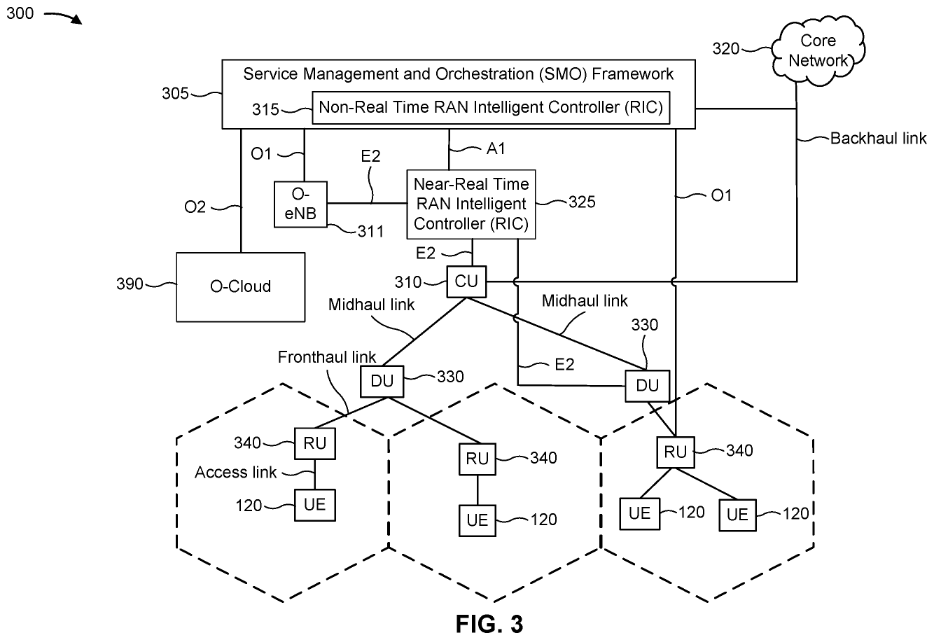

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

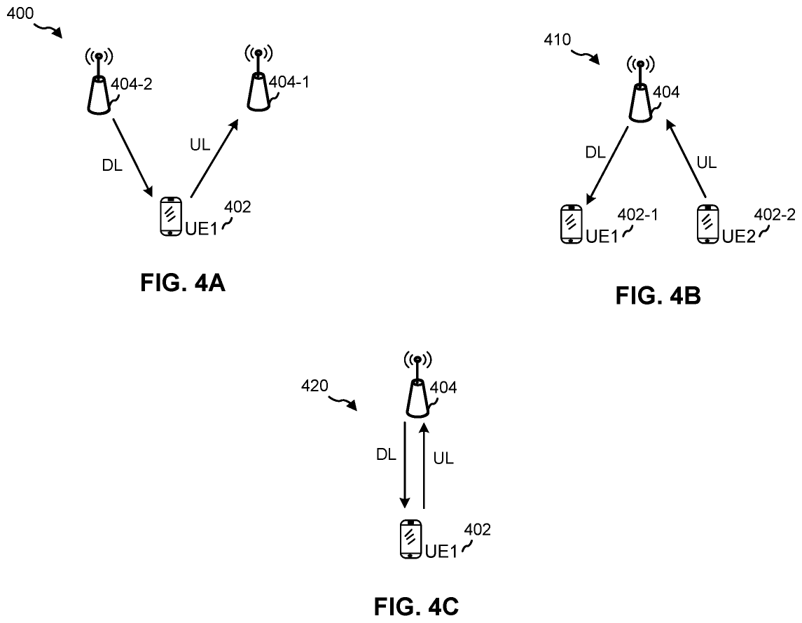

FIGS. 4A-4C are diagrams illustrating examples 400, 410, 420 of full duplex (FD) communication in accordance with the present disclosure. FD communication in a wireless network refers to simultaneous bi-directional communication between devices in the wireless network. For example, a UE operating in an FD mode may transmit an uplink communication and receive a downlink communication at the same time (e.g., in the same slot or the same symbol). HD communication in a wireless network refers to unidirectional communications (e.g., only downlink communication or only uplink communication) between devices at a given time (e.g., in a given slot or a given symbol).

The example 400 of FIG. 4A includes a UE1 402 (e.g., UE 120) and two network nodes (e.g., TRPs) 404-1, 404-2 (e.g., network nodes 110), where the UE1 402 is sending UL transmissions to the network node 404-1 and is receiving DL transmissions from the network node 404-2. In the example 400 of FIG. 4A, FD is enabled for the UE1 402, but not for the network nodes 404-1, 404-2. Put another way, the network nodes 404-1, 404-2 are operating in an HD mode. The example 410 of FIG. 4B includes two UEs, shown as UE1 402-1 and UE2 402-2, and a network node 404, where the UE1 402-1 is receiving a DL transmission from the network node 404 and the UE2 402-2 is transmitting an UL transmission to the network node 404. In the example 410 of FIG. 4B, FD is enabled for the network node 404, but not for the UE1 402-1 and the UE2 402-2 (e.g., the UE1 402-1 and the UE2 402-2 are operating in an HD mode). The example 420 of FIG. 4C includes a UE1 402 and a network node 404, where the UE1 402 is receiving a DL transmission from the network node 404 and the UE1 402 is transmitting an UL transmission to the network node 404. In the example 420 of FIG. 4C, FD is enabled for both the UE1 402 and the network node 404.

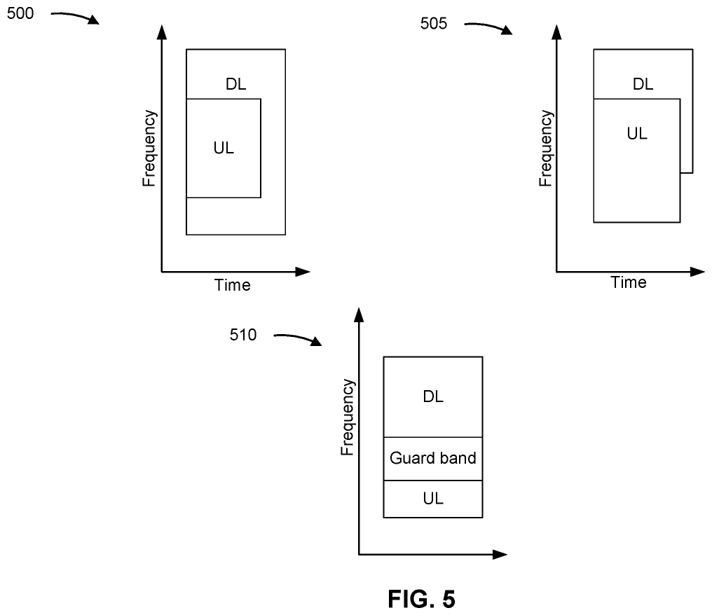

In some examples, a wireless communication device operating in an FD mode (e.g., the UE1 402 in examples 400 and/or 420, and/or the network node 404 in examples 410 and/or 420), may be operating in an IBFD mode or an SBFD mode. In an IBFD mode, a wireless communication device may transmit and receive communications on the same time and frequency resources (e.g., DL resources and UL resources may at least partially overlap in the time and frequency domains). In an SBFD mode, a wireless communication device may transmit and receive communications at the same time but on different frequency resources. In such examples, a DL resource may be separated from an UL resource by a guard band. Examples of IBFD operation and SBFD operation are described in more detail below in connection with FIG. 5.

As indicated above, FIGS. 4A-4C are provided as one or more examples. Other examples may differ from what is described with regard to FIGS. 4A-4C.

FIG. 5 is a diagram illustrating examples 500, 505, and 510 of full-duplex communication in a wireless network, in accordance with the present disclosure.

As shown in FIG. 5, examples 500 and 505 show examples of IBFD communication. In IBFD, a UE may transmit an uplink communication to a network node and receive a downlink communication from the network node on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

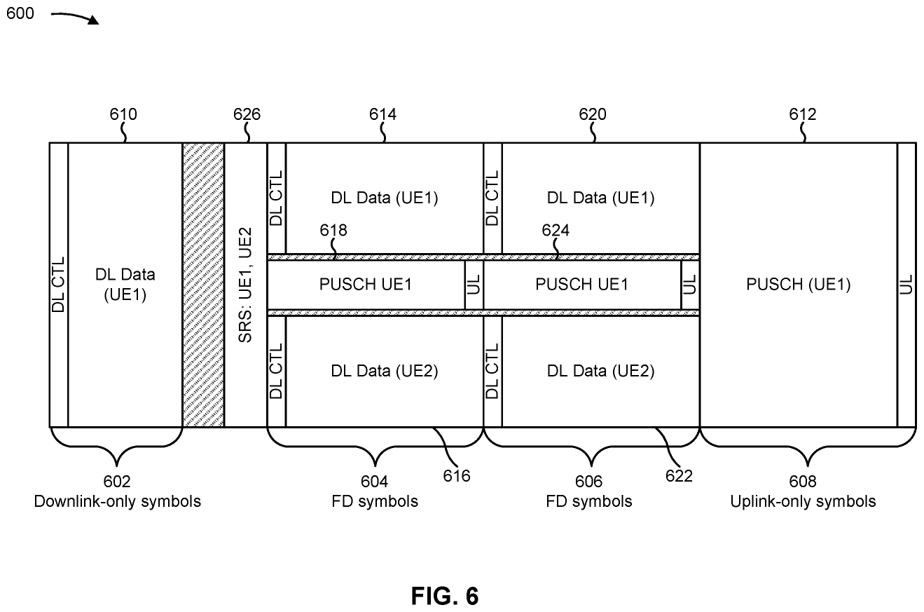

As further shown in FIG. 5, example 510 shows an example of SBFD communication, which may also be referred to as sub-band frequency division duplex (SBFDD) or flexible duplex. In SBFD, a network node may transmit a downlink communication to a UE and receive an uplink communication from the same UE or a different UE at the same time, but on different frequency resources. For example, the different frequency resources may be sub-bands of a frequency band, such as a time division duplexing (TDD) band. In this case, the frequency resources used for downlink communication may be separated from the frequency resources used for uplink communication, in the frequency domain, by a guard band. An example SBFD slot structure is described in more detail below in connection with FIG. 6.

As indicated above, FIG. 5 is provided as an example. Other examples may differ from what is described with respect to FIG. 5.

FIG. 6 is a diagram illustrating an example 600 of an SBFD slot format, in accordance with the present disclosure.

In some examples, a UE 120 may be configured with a TDD slot pattern, which may semi-statically schedule certain slots and/or symbols as downlink slots and/or symbols (e.g., to be used for downlink communications), certain slots and/or symbols as uplink slots and/or symbols (e.g., to be used for uplink communications), and/or certain slots and/or symbols as flexible slots and/or symbols (e.g., to be dynamically scheduled and/or used for either downlink communications or uplink communications). In some aspects, a UE 120 may be configured with a TDD slot pattern via an RRC TDD configuration parameter, such as one of a common TDD configuration parameter (sometimes referred to as tdd-UL-DL-ConfigurationCommon) or a dedicated TDD configuration parameter (sometimes referred to as tdd-UL-DL-ConfigurationDedicated). A slot which is configured as a downlink slot may referred to as a “D” slot, a slot which is configured as an uplink slot may referred to as a “U” slot, and a slot which is configured as a flexible slot may referred to as an “F” slot. Moreover, in examples in which a network node may be operating in an SBFD mode, such as by using the UL sub-bands and DL sub-bands shown in example 510 of FIG. 5, a slot in which the simultaneous transmissions occur may be referred to as an “SBFD” slot. An SBFD slot may contain downlink-only symbols, uplink-only symbols, and FD symbols (e.g., symbols in which simultaneous transmissions in the uplink and downlink may occur). In some examples, an SBFD slot may be associated with a D slot configured by a common TDD configuration parameter (e.g., tdd-UL-DL-ConfigurationCommon) or a dedicated TDD configuration parameter (e.g., tdd-UL-DL-ConfigurationDedicated), with certain symbols thereof scheduled for SBFD communications (e.g., containing both UL sub-bands and DL sub-bands). In some examples, an SBFD slot may contain both FD symbols (e.g., SBFD symbols) and HD symbols (e.g., non-SBFD symbols) in order to enable compatibility with symbol-level TDD uplink/downlink configuration.

More particularly, the example 600 shows an example SBFD slot format including downlink-only symbols 602, a first set of FD symbols 604, a second set of FD symbols 606, and uplink-only symbols 608. In some examples, the downlink-only symbols 602 may be associated with a downlink band 610 used by a network node 110 (e.g., network node 404) to transmit downlink communications to a UE 120 (e.g., UE 402), such as downlink control information (shown as “DL CTL”) and/or downlink data (shown as “DL Data”). For example, the downlink-only symbols 602 may be used by a network node 110 to transmit downlink control information and/or downlink data to a first UE 120, shown as “UE1” in FIG. 6. Similarly, the uplink-only symbols 608 may be associated with an uplink band 612 used by the first UE 120 to transmit uplink communications to the network node 110, such as uplink data (e.g., using a physical uplink shared channel (PUSCH)) and/or additional uplink information (shown simply as “UL” in FIG. 6).

The FD symbols 604 and 606 may be symbols in which the frequency band is used for both uplink and downlink transmissions. As described above in connection with FIG. 5, the uplink and downlink transmissions may occur in overlapping bands (e.g., for IBFD operation) or adjacent bands (e.g., for SBFD operation, as shown in FIG. 6). More particularly, the FD symbols 604 may include a first downlink sub-band 614 used by the network node 110 to transmit downlink communications, such as downlink control information and/or downlink data to the first UE 120, as well as a second downlink sub-band 616 used by the network node 110 to transmit downlink communications, such as downlink control information and/or downlink data to a second UE 120 (e.g., UE 402, shown as “UE2” in FIG. 6). Moreover, the FD symbols 604 may include an uplink sub-band 618 used by one of the first or second UEs 120 (e.g., the first UE 120 in the example shown in FIG. 6) to transmit uplink communications to the network node, such as uplink data in a PUSCH or other uplink information. Similarly, the FD symbols 606 may include a first downlink sub-band 620 and a second downlink sub-band 622 (which may be substantially similar to the first downlink sub-band 614 and the second downlink sub-band 616), as well as an uplink sub-band 624 (which may be substantially similar to the uplink sub-band 618). The SBFD slot structure shown in FIG. 6 may include additional symbols and/or bands, such as symbols used as sounding reference signal (SRS) resources 626 (e.g., resources used by the first and/or second UE 120 to transmit SRSs to the network node 110) and/or guard symbols and/or bands separating downlink and uplink transmissions and/or sub-bands (shown using cross-hatching in FIG. 6).

In this way, in a given SBFD symbol, an HD UE 120 (e.g., UE1 402-1 and/or UE2 402-2 of example 410 of FIG. 4B) either transmits in an uplink band (e.g., uplink band 612, uplink sub-band 618, or uplink sub-band 624) or receives in a downlink band (e.g., downlink band 610, downlink sub-band 614, downlink sub-band 616, downlink sub-band 620, or downlink sub-band 622). However, an FD UE 120 (e.g., UE1 402 of example 400 of FIG. 4A and/or UE1 402 of example 420 of FIG. 4C) may transmit in an uplink band (e.g., uplink sub-band 618 and/or uplink sub-band 624) and/or receive in a downlink band (e.g., downlink sub-band 614, downlink sub-band 616, downlink sub-band 620, and/or downlink sub-band 622) in the same symbol. For example, in the example shown in FIG. 6, the first UE 120 (e.g., UE1) may simultaneously transmit communications in the uplink sub-band 618 and receive communications in the downlink sub-band 614, and/or may simultaneously transmit communications in the uplink sub-band 624 and receive communications in the downlink sub-band 620.

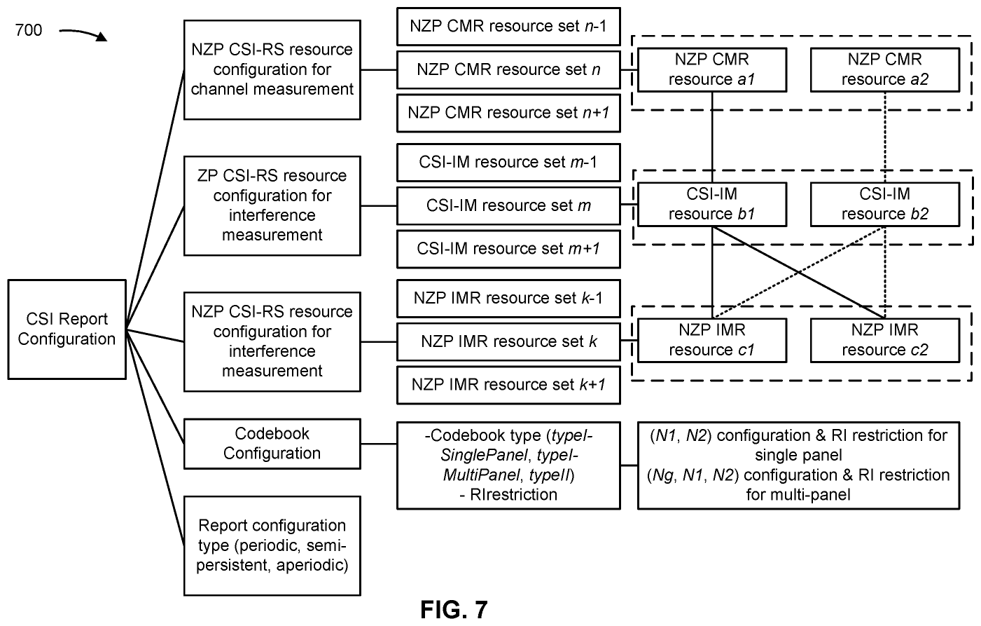

In some examples, a UE 120 may be configured to perform certain measurements associated with an HD set of symbols (e.g., the downlink-only symbols 602) and certain other measurements associated with an FD set of symbols (e.g., the FD symbols 604 and/or the FD symbols 606). For example, a UE may receive one or more CSI reporting settings configuring one or more CSI reports associated with an HD set of symbols and/or an FD set of symbols. The one or more CSI reports may be used by the UE 120 to report, to a network node, channel measurements and/or interference measurements associated with the HD set of symbols and/or the FD set of symbols. Aspects of a CSI report setting are described in more detail below in connection with FIG. 7.

As indicated above, FIG. 6 is provided as an example. Other examples may differ from what is described with respect to FIG. 6.

FIG. 7 is a diagram illustrating an example 700 of a CSI reporting setting, in accordance with the present disclosure.

A CSI reporting setting may be used by a network node 110 to configure a UE 120 with multiple resources for performing certain measurements associated a channel between the network node 110 and the UE 120 and/or with certain parameters indicating how the measurements are to be reported by the UE 120 to the network node 110. More particularly, a CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. For example, the network node 110 may configure a set of CSI-RS resources using a CSI reporting setting (e.g., a CSI report configuration). A CSI reporting setting may indicate resources and/or parameters associated with a CSI report to be transmitted by the UE 120 to the network node 110. For example, as shown by example 700, the CSI reporting setting may indicate a non-zero-power (NZP) CSI-RS resource configuration for channel measurement (sometimes referred to herein as a channel measurement resource (CMR) configuration), a zero-power (ZP) CSI-RS resource configuration for interference measurement (sometimes referred to herein as an interference measurement resource (IMR) configuration), an NZP CSI-RS resource configuration for interference management, a codebook configuration, and/or a report configuration type, among other information.

The codebook configuration may indicate a codebook type associated with the CSI report, such as one of a type I, single panel codebook (sometimes referred to as typeI-SinglePanel); a type I, multi-panel codebook (sometimes referred to as typeI-MultiPanel); or a type II codebook (sometimes referred to as typeII). The codebook configuration may further indicate a rank indicator (RI) restriction (sometimes referred to as RIrestriction). In some examples, the codebook configuration may indicate an antenna array configuration, such as (N1, N2) and a corresponding RI restriction for a single panel configuration, and/or (Ng, N1, N2) and a corresponding RI restriction for a multi-panel configuration. The report configuration type may indicate a periodicity with which the UE 120 is to transmit the CSI report, such as whether the CSI report a periodic report, a semi-persistent report, or an aperiodic report.

The CMR configuration may indicate resources associated with the UE 120 performing a channel measurement using NZP CSI-RS resources (e.g., resources in which the network node 110 transmits a CSI-RS to the UE 120). More particularly, the CMR configuration may indicate a NZP CMR resource set (sometimes referred to herein as a CSI-RS resource set) to be used for performing the channel measurement. For example, in the example 700, the CMR configuration indicates that the NZP CMR resource set n should be used for performing the channel measurement. The CSI-RS resource set may include one or more NZP CMR resources (sometimes referred to herein as CSI-RS resources), such as NZP CMR resource a1 and NZP CMR resource a2 in the example 700.

The IMR configuration may indicate ZP resources (e.g., resources in which the network node 110 does not transmit a CSI-RS to the UE 120) associated with the UE 120 performing an interference measurement. More particularly, the IMR configuration may indicate a CSI-IM resource set to be used for performing the interference measurement. For example, in the example 700, the IMR configuration indicates that the CSI-IM resource set m should be used for performing the interference measurement. The CSI-IM resource set may include one or more CSI-IM resources, such as CSI-IM resource b1 and CSI-IM resource b2 in the example 700.

The NZP CSI-RS resource configuration for interference measurement may indicate NZP resources associated with the UE 120 performing an NZP interference measurement (e.g., an interference measurement based at least in part on a CSI-RS transmitted by the network node 110 to the UE 120). More particularly, the NZP CSI-RS resource configuration for interference measurement may indicate an NZP IMR resource set to be used for performing the NZP interference measurement. For example, in example 700, the NZP CSI-RS resource configuration for interference measurement indicates that the NZP IMR resource set k should be used for performing the NZP interference measurement. The NZP IMR resource set may include one or more NZP IMR resources, such as NZP IMR resource c/and NZP IMR resource c2 in the example 700.

The CSI reporting setting may associate each CSI-RS resource with a corresponding CSI-IM resource. More particularly, each CSI-RS resource may be resource-wise associated with a corresponding CSI-IM resource by the ordering of the CSI-RS resource and the CSI-IM resource in the corresponding resource sets. In that regard, a number of CSI-RS resources indicated by the CSI reporting setting may equal a number of CSI-IM resources indicated by the CSI reporting setting. Moreover, a CSI-RS resource and an associated CSI-IM resource may occur within a same slot. Thus, in example 700, NZP CMR resource a1 may occur in a same slot as CSI-IM resource b1, NZP CMR resource a2 may occur in a same slot as CSI-IM resource b2, and so forth.

Based at least in part on the measurements of the CSI-RS resources and the CSI-IM resources, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a RI, or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

In some examples, such as examples involving SBFD-aware UEs, a UE may be configured to report channel measurements associated with an HD set of symbols as well as channel measurements associated with an FD set of symbols. In such examples, the UE may be configured with multiple CSI report settings (sometimes referred to as CSI-ReportConfig #1 and CSI-ReportConfig #2), with one of the CSI report settings and/or a corresponding CSI report associated with an FD set of symbols and with the other one of the CSI report settings and/or a corresponding CSI report associated with an HD set of symbols (e.g., CSI-ReportConfig #1 may be associated with SBFD channel measurements and/or CSI-ReportConfig #2 may be associated with non-SBFD channel measurements). Put another way, the UE may be configured to perform separate CSI reporting for SBFD symbols and non-SBFD symbols. In such examples, the UE may be configured with two CSI-RS resources (sometimes referred to as CSI-RS #1, which may have occasions in SBFD symbols only, and CSI-RS #2, which may have occasions in non-SBFD symbols only), and thus each CSI report setting and/or CSI report may be associated with a corresponding CSI-RS for performing channel measurements (e.g., CSI-ReportConfig #1 may be associated with CSI-RS #1 for reporting SBFD measurements and CSI-ReportConfig #2 may be associated with CSI-RS #2 for reporting non-SBFD measurements). In some other examples, the UE may be configured with a single periodic or semi-persistent CSI-RS resource having occasions in both SBFD symbols and non-SBFD symbols, and thus each CSI report setting and/or CSI report may be associated with the same CSI-RS for performing channel measurements (e.g., CSI-ReportConfig #1 may be associated with occasions of the resource associated with SBFD symbols and CSI-ReportConfig #2 may be associated with occasions of the resource associated with non-SBFD symbols).

In some other examples, a UE may be configured with a single CSI report setting, with the single CSI report setting and/or a corresponding CSI report associated with both an FD set of symbols (e.g., SBFD channel measurements) and an HD set of symbols (e.g., non-SBFD channel measurements). Put another way, the UE may be configured to perform a same CSI reporting for SBFD symbols and non-SBFD symbols. In such examples, the UE may be configured with two CSI-RS resources (e.g., CSI-RS #1 and CSI-RS #2), and thus the single CSI report setting and/or CSI report may be associated with multiple CSI-RSs for performing channel measurements (e.g., CSI-RS #1 may be used for reporting SBFD measurements in the single CSI report and CSI-RS #2 may be used for reporting non-SBFD measurements in the single CSI report). In some other examples, the UE may be configured with a single periodic or semi-persistent CSI-RS resource having occasions in both SBFD symbols and non-SBFD symbols, and the single CSI report setting and/or CSI report may be associated with the same CSI-RS for performing channel measurements (e.g., FD measurements may be performed using occasions of the resource associated with SBFD symbols and HD measurements may be performed using occasions of the resource associated with non-SBFD symbols).

In examples in which a UE is configured to report channel measurements associated with an HD set of symbols and channel measurements associated with an FD set of symbols, it may be desirable for the UE to also report interference measurements associated with the HD set of symbols as well as the FD set of symbols. However, there is currently no mechanism for configuring a UE to perform separate interference measurements for an HD set of symbols and an FD set of symbols. Moreover, while a channel may remain relatively stable within a slot containing both FD symbols and HD symbols (e.g., the SBFD slot described above in connection with FIG. 6), interference may significantly differ between symbols due to CLI and other potential colliding transmissions within FD symbols. Accordingly, in some instances, it may be desirable to configure interference measurements differently than channel measurements in SBFD slots.

Some techniques and apparatuses described herein enable configuration of a UE with CSI-IM resources for performing interference measurements associated with FD sets of symbols and HD sets of symbols. Put another way, some techniques and apparatuses described herein enable an IMR configuration supporting FD and HD measurements. In some aspects, an IMR configuration (e.g., a configuration of one or more CSI-IM resources) may follow a CMR configuration (e.g., a configuration of one or more CSI-RS resources), such as by configuring separate CSI-IM resources when separate CSI-RS resources are configured, and/or by configuring one CSI-IM resource with separate occasions used for FD interference measurements and HD interference measurements when one CSI-RS resource with separate occasions are used for FD channel measurements and HD channel measurements. In some aspects, one or more CSI-IM resources used for FD and HD interference measurements may be configured in a single slot having mixed symbol types, such as a slot including FD symbols (e.g., SBFD symbols) and HD symbols (e.g., non-SBFD symbols), and/or a CSI-IM resource may be associated with a CSI-IM pattern spanning multiple REs in time and/or frequency such that the CSI-IM resource spans both FD and HD symbols. As a result, a UE may report more relevant interference measurements to a network node associated with FD operation, and the network node may in turn may perform improved selection of communication parameters, resulting in reduced communication errors, and thus reduced power, computing, and network resource consumption otherwise required for correcting communication errors.

As indicated above, FIG. 7 is provided as an example. Other examples may differ from what is described with respect to FIG. 7.

FIG. 8 is a diagram of an example 800 associated with CSI-IM resources for FD sets of symbols, in accordance with the present disclosure. As shown in FIG. 8, a network node 110 (e.g., a CU, a DU, and/or an RU) may communicate with a UE 120. In some aspects, the network node 110 and the UE 120 may be part of a wireless network (e.g., wireless network 100). The network node 110 and the UE 120 may have established a wireless connection prior to operations shown in FIG. 8. In some aspects, one or both of the network node 110 and the UE 120 may have a capability of FD operation. For example, the network node 110 may correspond to the network node 404 that is capable of operating in an FD mode as described above in connection with FIGS. 4B and 4C, and/or the UE 120 may correspond to the UE1 402 that is capable of operating in an FD mode as described above in connection with FIGS. 4A and 4C.

As shown by reference number 805, the network node 110 may transmit, and the UE 120 may receive, configuration information. In some aspects, the UE 120 may receive the configuration information via one or more of RRC signaling, one or more MAC control elements (MAC-CEs), and/or downlink control information (DCI), among other examples. In some aspects, the configuration information may include an indication of one or more configuration parameters (e.g., already known to the UE 120 and/or previously indicated by the network node 110 or another network device) for selection by the UE 120, and/or explicit configuration information for the UE 120 to use to configure the UE 120, among other examples.

In some aspects, the configuration information may indicate one or more CSI report configurations (e.g., one or more CSI report settings) that configure one or more CSI-IM resources (e.g., the configuration information may include an IMR configuration). The one or more CSI-IM resources may include a CSI-IM resource associated with an FD set of symbols (sometimes referred to herein as an FD CSI-IM resource), such as an FD set of symbols 810 as shown in FIG. 8, and a CSI-IM resource associated with an HD set of symbols (sometimes referred to herein as an HD CSI-IM resource), such as HD set of symbols 815 shown in FIG. 8. The configuration information may indicate additional information associated with one or more CSI reports and/or one or more CSI report settings, such as any of the information described above in connection with FIG. 7. In that regard, the one or more CSI report configurations (e.g., the one or more CSI report settings) may also configure one or more CSI-RS resources (e.g., the configuration information may include a CMR configuration). Moreover, the one or more CSI-RS resources may include a CSI-RS resource associated with the FD set of symbols (sometimes referred to herein as an FD CSI-RS resource), and a CSI-RS resource associated with the HD set of symbols (sometimes referred to herein as an HD CSI-RS resource).

In some aspects, the one or more CSI report configurations may configure multiple CSI reports, with a first CSI report, of the multiple CSI reports, corresponding to the FD set of symbols (sometimes referred to as an SBFD CSI report) and a second CSI, of the multiple CSI reports, corresponding to the HD set of symbols (sometimes referred to as a non-SBFD CSI report). Put another way, the one or more CSI report configurations may configure a first CSI report configuration (e.g., a first CSI report setting) associated with the FD set of symbols and a second CSI report configuration (e.g., a second CSI report setting) associated with the HD set of symbols. In some other aspects, the one or more CSI report configurations may configure a single CSI report, with the single CSI report corresponding to both the FD set of symbols and the HD set of symbols. Put another way, the one or more CSI report configurations may include a single CSI report configuration (e.g., a single CSI report setting) that configures a single report for reporting channel and/or interference measurements associated with both the FD set of symbols and the HD set of symbols.

Moreover, in some aspects, the one or more CSI report configurations may configure multiple resources for performing interference measurements associated with the FD set of symbols and the HD set of symbols, while, in some other aspects, the one or more CSI report configurations may configure a single resource for performing interference measurements associated with both the FD set of symbols and the HD set of symbols. That is, in some aspects, the FD CSI-IM resource may be a different resource than the HD CSI-IM resource, while, in some other aspects, the FD CSI-IM resource may be a same resource as the HD CSI-IM resource. For example, the FD CSI-IM resource and the HD CSI-IM resource may be associated with a same periodic or semi-persistent resource having occasions in both FD symbols and HD symbols, with the FD CSI-IM resource being a first occasion of the periodic or semi-persistent resource occurring in the FD set of symbols, and with the HD CSI-IM resource being a second occasion of the periodic or semi-persistent resource occurring in the HD set of symbols.

In some aspects, an IMR configuration (e.g., the configuration of the one or more CSI-IM resources for performing interference measurements) may follow a CMR configuration (e.g., a configuration of one or more CSI-RS resources for performing channel measurements). For example, the one or more CSI-IM resources may be configured in a similar way as one or more CSI-RS resources. Thus, in aspects in which multiple CSI report settings are configured for channel measurements, with each CSI report setting being associated with a corresponding CSI-RS resource (one for FD symbols and one for HD symbols), the multiple CSI report settings may similarly configure multiple CSI-IM resources for interference measurements, one for interference measurements associated with FD symbols and one for interference measurements associated HD symbols. Similarly, in aspects in which multiple CSI report settings are configured for channel measurement, with each CSI report setting being associated with a same CSI-RS resource (e.g., a periodic or semi-persistent resource having occasions in both FD symbols and HD symbols), the multiple CSI report settings may similarly configure a single CSI-IM resource for interference measurements, such as a periodic or semi-persistent resource having occasions in both FD symbols and HD symbols. Moreover, in aspects in which a single CSI report setting is configured for channel measurements, with the single CSI report setting being associated with multiple CSI-RS resources (one for FD symbols and one for HD symbols), the single CSI report setting may similarly configure multiple CSI-IM resources for interference measurements, one for FD symbols and one for HD symbols. Similarly, in aspects in which a single CSI report setting is configured for channel measurements, with the single CSI report setting being associated with a single CSI-RS resource (e.g., a periodic or semi-persistent resource having occasions in both FD symbols and HD symbols), the single CSI report setting may similarly configure a single CSI-IM resource for interference measurements, such as a periodic or semi-persistent resource having occasions in both FD symbols and HD symbols.

In some other aspects, an IMR configuration may not necessarily follow the CMR configuration design, such that a CSI-IM resource configuration may not be the same as a CSI-RS resource configuration. This may improve flexibility in a network, such as by permitting flexible scheduling of interference measurements without being constrained to a channel-measurement framework. For example, in some aspects, a single resource (e.g., a periodic or semi-persistent resource having occasions in both FD symbols and HD symbols) may be configured for purposes of a CMR configuration, and multiple resources (e.g., a first resource associated with FD symbols and a second resource associated with HD symbols) may be configured for purposes of an IMR configuration. In such aspects, configuring a separate CSI-IM resource for FD interference measurements (e.g., a resource for performing interference measurements in SBFD symbols) and HD measurements (e.g., a resource for performing measurements in non-SBFD symbols) may enable linking one or more of the CSI-IM resources to more than one CSI report, regardless of how a corresponding CMR configuration is designed.

The UE 120 may configure itself based at least in part on the configuration information. In some aspects, the UE 120 may be configured to perform one or more operations described herein based at least in part on the configuration information.

As shown by reference numbers 820 and 825, the UE 120 may perform interference measurements in one or more sets of symbols based at least in part on the configuration information. For example, as shown by reference number 820, the UE 120 may perform interference measurements associated with an FD set of symbols (e.g., FD set of symbols 810) using the FD CSI-IM resource. Additionally, or alternatively, as shown by reference number 825, in some aspects, the UE 120 may perform interference measurements associated with an HD set of symbols (e.g., HD set of symbols 815) using the HD CSI-IM resource.

In some aspects, a CSI-IM resource (e.g., a resource associated with performing interference measurements) and a corresponding CSI-RS resource (e.g., a resource associated with performing channel measurements) may occur within a same slot, while, in some other aspects, a CSI-IM resource and a corresponding CSI-RS resource may occur within different slots. For example, in some aspects, such as in aspects in which a single resource is associated with the FD CSI-IM resource and the HD CSI-IM resource (e.g., aspects in which each CSI-IM resource is associated with a different occasion of a periodic or semi-persistent resource), a CSI-IM resource (e.g., one of the FD CSI-IM resource or the HD CSI-IM resource) and a corresponding CSI-RS resource (e.g., a corresponding one of the FD CSI-RS resource or the HD CSI-RS resource) may be scheduled within a same slot. This may simplify logic needed at the UE 120 to associate an instance of a CSI-RS resource and a corresponding CSI-IM resource. Accordingly, in some aspects, the FD CSI-IM resource may occur within a same slot as an FD CSI-RS resource, and/or the HD CSI-IM resource may occur within a same slot as an HD CSI-RS resource. Moreover, regardless of whether a single resource or multiple resources are configured for the FD CSI-RS resource and the HD CSI-RS resource, restricting a CSI-IM resource to be within a same slot as a corresponding CSI-RS resource may simplify operation in terms of the UE 120 determining a timing requirement, aperiodic triggering, or similar operation parameters.

In some other aspects, such as in aspects in which one resource is associated with the FD CSI-IM resource and a different resource is associated with the HD CSI-IM resource, a CSI-IM resource may not be restricted to a same slot as a corresponding CSI-RS resource, because an association between a CSI-IM resource and a corresponding CSI-RS resource may be implicit from the configuration information. Accordingly, in some aspects, a CSI-IM resource may be located in a different slot than a corresponding CSI-RS resource. That is, the FD CSI-IM resource may occur in a different slot than an FD CSI-RS resource, and/or the HD CSI-IM resource may occur in a different slot than an HD CSI-RS resource. Moreover, when a CSI-IM resource and a corresponding CSI-RS resource occur within different slots, the slots may be spaced apart no more than a specified, pre-configured, or configured maximum gap (e.g., a maximum permissible number of slots). For example, in aspects in which the maximum permissible number of slots is specified, pre-configured, or configured as four slots, a CSI-IM resource may be located with a slot that is no more than four slots away from a slot in which a corresponding CSI-RS resource is located.

In some aspects, a CSI-IM resource and/or a CSI-RS resource may be associated with a slot having both FD symbols (e.g., SBFD symbols) and non-FD symbols (e.g., non-SBFD symbols), such as the SBFD slot described above in connection with FIG. 6. Accordingly, in some aspects, the network node 110 may take into account symbol types of an SBFD slot or a similar slot when configuring CSI-IM resources and/or CSI-RS resources. For example, the network node 110 may schedule the FD CSI-IM resource to overlap with FD symbols in a slot and/or the network node 110 may schedule the HD CSI-IM resource to overlap with HD symbols in a slot.

Additionally, or alternatively, in some aspects, a CSI-IM resource and/or a CSI-RS resource may collide with a wrong symbol type, such as when an HD CSI-IM resource and/or an HD CSI-RS resource overlaps with one or more FD symbols in a slot, and/or when an FD CSI-IM resource and/or an FD CSI-RS resource overlaps with one or more HD symbols in a slot. In such cases, a UE 120 may be specified, pre-configured, and/or configured to refrain from performing certain channel and/or interference measurements, or, if channel and/or interference measurements are performed, to omit the channel and/or interference measurements from a corresponding CSI report.

For example, in some aspects, the UE 120 may refrain from measuring, and/or may omit from one or more CSI reports, both channel and interference measurements when at least one of a CSI-IM resource or a corresponding CSI-RS overlaps with a wrong symbol type. More particularly, in aspects in which one of an HD CSI-IM resource or an HD CSI-RS resource overlaps with at least one FD symbol, the UE 120 may refrain from measuring, and/or may omit from one or more CSI reports (which are described in more detail below in connection with reference number 830), measurements associated with both the HD CSI-IM resource and the HD CSI-RS resource. Similarly, in aspects in which one of an FD CSI-IM resource or an FD CSI-RS resource overlaps with at least one HD symbol, the UE 120 may refrain from measuring, and/or may omit from the one or more CSI reports, measurements associated with both the FD CSI-IM resource and the FD CSI-RS resource.

In some other aspects, the UE 120 may refrain from measuring, and/or may omit from one or more CSI reports, only channel and/or interference measurements associated with a resource that overlaps with a wrong symbol type. More particularly, in aspects in which one of the HD CSI-IM resource or the HD CSI-RS resource overlaps with at least one FD symbol, the UE 120 may refrain from measuring, and/or may omit from the one or more CSI reports, measurements associated with the one of the HD CSI-IM resource or the HD CSI-RS resource that overlaps with the at least one FD symbol. Similarly, in aspects in which one of the FD CSI-IM resource or the FD CSI-RS resource overlaps with at least one HD symbol, the UE 120 may refrain from measuring, and/or may omit from the one or more CSI reports, measurements associated with the one of the FD CSI-IM resource or the FD CSI-RS resource that overlaps with the at least one HD symbol.

Moreover, in some aspects, if a subset of symbols associated with a CSI-IM resource or a CSI-RS resource collides with a wrong symbol type, the UE 120 may refrain from measuring, and/or may omit from the one or more CSI reports, measurements associated with the entire resource (e.g., measurements associated with the wrong symbol type and the correct symbol type). For example, a CSI-RS resource may be associated with multiple code division multiplexing (CDM) groups with time division multiplexing (TDM) (e.g., different CDM groups may be on different symbols). In such aspects, if a first CDM group is on a symbol that collides with a wrong symbol type but a second CDM group is on a symbol that collides with a correct symbol type, the UE 120 may refrain from measuring, and/or may omit from the one or more CSI reports, measurements associated with all CDM groups. Similarly, a CSI-IM resource may be associated with a pattern that spans multiple symbols. In such aspects, if the CSI-IM resource collides with at least one wrong symbol type (e.g., if an FD CSI-IM resource overlaps with at least one HD symbol or if an HD CSI-IM resource overlaps with at least one FD symbol), the UE 120 may refrain from measuring, and/or may omit from the one or more CSI reports, measurements associated with the entire CSI-IM resource.

In some aspects, a single CSI-IM resource may be used for performing both FD measurements and HD measurements (e.g., an FD CSI-IM resource and an HD CSI-IM resource may be associated with a same resource). For example, a CSI-IM resource may be associated with a pattern that spans multiple symbols in a time domain and/or that spans multiple resource elements (REs) in a time domain and/or a frequency domain, such that a first subset of the total symbols and/or REs are associated with FD operation (e.g., the first subset of symbols and/or REs are in SBFD symbols) and such that a second subset of the total symbols and/or REs are associated with HD operation (e.g., the second subset of symbols and/or REs are in non-SBFD symbols). In such aspects, the single resource may be used by the UE 120 to perform both FD interference measurements (e.g., SBFD interference measurements) and HD interference measurements (e.g., non-SBFD interference measurements). Put another way, performing the interference measurements associated with the FD set of symbols (as shown by reference number 820) and the HD set of symbols (as shown by reference number 825) may include performing interference measurements associated with FD set of symbols and the HD set of symbols using the same resource.

In some other aspects, multiple CSI-IM resources may be used for performing both FD measurements and HD measurements (e.g., an FD CSI-IM resource may be used to perform FD measurements and a separate HD CSI-IM resource may be used to perform HD measurements), but the CSI-IM resources may be configured to be within the same slot. For example, the FD CSI-IM resource may be associated with a first set of symbols in a slot, and the HD CSI-IM resource may be associated with a second set of symbols in the slot. In some aspects, an inter-cell interference component may be similar across symbols within a same slot. Thus, by configuring the FD CSI-IM resource and the HD CSI-IM resource within the same slot, the interference measurements may be used for a purpose of quantifying CLI associated with the FD operation (e.g., SBFD CLI). In some aspects, when the FD CSI-IM resource and the HD CSI-IM resource are configured to occur within the same slot and certain occasions of the FD CSI-IM resource and the HD CSI-IM resource occur within a slot having one symbol type, the UE 120 may use only one of the two CSI-IM resources for performing interference measurements. For example, when occasions of the FD CSI-IM resource and the HD CSI-IM resource occur within an FD slot (e.g., an SBFD slot), the UE 120 may only use the FD CSI-IM resource for performing interference measurements. Similarly, when occasions of the FD CSI-IM resource and the HD CSI-IM resource occur within an HD slot (e.g., a non-SBFD slot), the UE 120 may only use the HD CSI-IM resource for performing interference measurements.

As shown by reference number 830, the UE 120 may transmit, and the network node 110 may receive, one or more CSI reports reporting the interference measurements associated with the FD set of symbols and/or the HD set of symbols. For example, in aspects in which the UE 120 is configured with two CSI report settings configuring two CSI reports, the UE 120 may transmit, and the network node 110 may receive, a first CSI report reporting interference measurements associated with the FD set of symbols and a second CSI report reporting interference measurements associated with the HD set of symbols. In aspects in which the UE 120 is configured with one CSI report setting configuring a single CSI report, the UE 120 may transmit, and the network node 110 may receive, a single CSI report reporting interference measurements associated with the FD set of symbols and interference measurements associated with the HD set of symbols.

Based at least in part on the network node 110 configuring the UE 120 with one or more CSI-IM resources associated with an FD set of symbols and an HD set of symbols, the UE 120 and/or the network node 110 may conserve computing, power, network, and/or communication resources that may have otherwise been consumed using traditional IMR configurations. For example, based at least in part on the network node 110 configuring the UE 120 with one or more CSI-IM resources associated with an FD set of symbols and an HD set of symbols, the network node 110 may receive, from the UE 120, more accurate interference measurements as compared to measurements associated with traditional IMR configurations, resulting in improved selection of communication parameters by the network node 110 and thus a reduced error rate of communications between the network node 110 and the UE 120, which may conserve computing, power, network, and/or communication resources that may have otherwise been consumed to detect and/or correct communication errors.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with CSI-IM resources for FD sets of symbols.

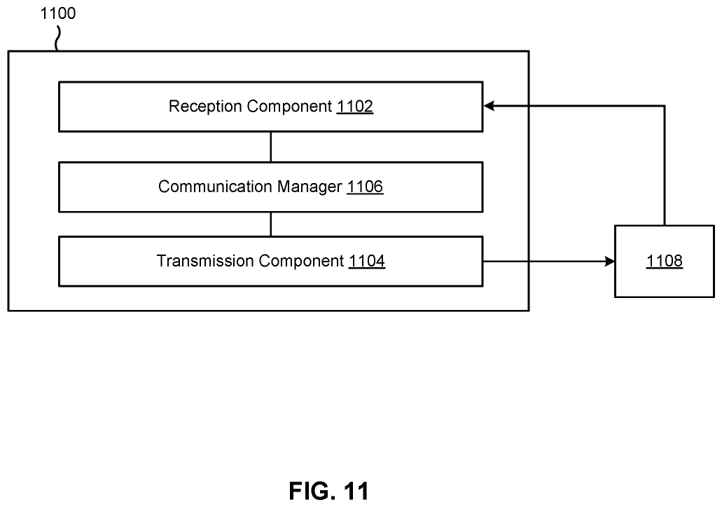

As shown in FIG. 9, in some aspects, process 900 may include receiving configuration information indicating one or more CSI report configurations that configure one or more CSI-IM resources, the one or more CSI-IM resources including a CSI-IM resource associated with an FD set of symbols and a CSI-IM resource associated with an HD set of symbols (block 910). For example, the UE (e.g., using reception component 1102 and/or communication manager 1106, depicted in FIG. 11) may receive configuration information indicating one or more CSI report configurations that configure one or more CSI-IM resources, the one or more CSI-IM resources including a CSI-IM resource associated with an FD set of symbols and a CSI-IM resource associated with an HD set of symbols, as described above.

As further shown in FIG. 9, in some aspects, process 900 may include performing interference measurements associated with at least one of the FD set of symbols, using the CSI-IM resource associated with the FD set of symbols, or the HD set of symbols, using the CSI-IM resource associated with the HD set of symbols (block 920). For example, the UE (e.g., using communication manager 1106, depicted in FIG. 11) may perform interference measurements associated with at least one of the FD set of symbols, using the CSI-IM resource associated with the FD set of symbols, or the HD set of symbols, using the CSI-IM resource associated with the HD set of symbols, as described above.

As further shown in FIG. 9, in some aspects, process 900 may include transmitting one or more CSI reports reporting the interference measurements associated with the at least one of the FD set of symbols or the HD set of symbols (block 930). For example, the UE (e.g., using transmission component 1104 and/or communication manager 1106, depicted in FIG. 11) may transmit one or more CSI reports reporting the interference measurements associated with the at least one of the FD set of symbols or the HD set of symbols, as described above.

Process 900 may include additional aspects, such as any single aspect or any combination of aspects described below and/or in connection with one or more other processes described elsewhere herein.

In a first aspect, the one or more CSI report configurations include a first CSI report configuration associated with the FD set of symbols and a second CSI report configuration associated with the HD set of symbols, and the one or more CSI reports include a first CSI report reporting interference measurements associated with the FD set of symbols and a second CSI report reporting interference measurements associated with the HD set of symbols.

In a second aspect, alone or in combination with the first aspect, the CSI-IM resource associated with the FD set of symbols is a different resource than the CSI-IM resource associated with the HD set of symbols.

In a third aspect, alone or in combination with one or more of the first and second aspects, the CSI-IM resource associated with the FD set of symbols is associated with a first occasion of a periodic or semi-persistent resource, and the CSI-IM resource associated with the HD set of symbols is associated with a second occasion of the periodic or semi-persistent resource.

In a fourth aspect, alone or in combination with one or more of the first through third aspects, the one or more CSI report configurations include a single CSI report configuration, and the one or more CSI reports include a single CSI report reporting interference measurements associated with the FD set of symbols and interference measurements associated with the HD set of symbols.

In a fifth aspect, alone or in combination with one or more of the first through fourth aspects, the CSI-IM resource associated with the FD set of symbols is a different resource than the CSI-IM resource associated with the HD set of symbols.

In a sixth aspect, alone or in combination with one or more of the first through fifth aspects, the CSI-IM resource associated with the FD set of symbols is associated with a first occasion of a periodic or semi-persistent resource, and the CSI-IM resource associated with the HD set of symbols is associated with a second occasion of the periodic or semi-persistent resource.

In a seventh aspect, alone or in combination with one or more of the first through sixth aspects, at least one of the CSI-IM resource associated with the FD set of symbols occurs within a same slot as CSI-RS resource associated with the FD set of symbols, or the CSI-IM resource associated with the HD set of symbols occurs within a same slot as a CSI-RS resource associated with the HD set of symbols.

In an eighth aspect, alone or in combination with one or more of the first through seventh aspects, at least one of: the CSI-IM resource associated with the FD set of symbols occurs within a first slot and a CSI-RS resource associated with the FD set of symbols occurs within a second slot, or the CSI-IM resource associated with the HD set of symbols occurs within the first slot and a CSI-RS resource associated with the HD set of symbols occurs within the second slot.

In a ninth aspect, alone or in combination with one or more of the first through eighth aspects, the first slot and the second slot are separated by no more than a maximum permissible number of slots.

In a tenth aspect, alone or in combination with one or more of the first through ninth aspects, the one or more CSI report configurations further configure one or more CSI-RS resources, the one or more CSI-RS resources including a CSI-RS resource associated with the HD set of symbols, one of the CSI-IM resource associated with the HD set of symbols or the CSI-RS resource associated with the HD set of symbols overlaps with at least one FD symbol, and process 900 includes omitting, from the one or more CSI reports, measurements associated with the CSI-IM resource associated with the HD set of symbols and the CSI-RS resource associated with HD set of symbols based at least in part on the one of the CSI-IM resource associated with the HD set of symbols or the CSI-RS resource associated with the HD set of symbols overlapping with the at least one FD symbol.

In an eleventh aspect, alone or in combination with one or more of the first through tenth aspects, the one or more CSI report configurations further configure one or more CSI-RS resources, the one or more CSI-RS resources including a CSI-RS resource associated with the HD set of symbols, one of the CSI-IM resource associated with the HD set of symbols or the CSI-RS resource associated with the HD set of symbols overlaps with at least one FD symbol, and process 900 includes omitting, from the one or more CSI reports, measurements associated with the one of the CSI-IM resource associated with the HD set of symbols or the CSI-RS resource associated with the HD set of symbols that overlaps with the at least one FD symbol based at least in part on the one of the CSI-IM resource associated with the HD set of symbols or the CSI-RS resource associated with the HD set of symbols overlapping with the at least one FD symbol.

In a twelfth aspect, alone or in combination with one or more of the first through eleventh aspects, the one or more CSI report configurations further configure one or more CSI-RS resources, the one or more CSI-RS resources including a CSI-RS resource associated with the FD set of symbols, one of the CSI-IM resource associated with the FD set of symbols or the CSI-RS resource associated with the FD set of symbols overlaps with at least one HD symbol, and process 900 includes omitting, from the one or more CSI reports, measurements associated with the CSI-IM resource associated with the FD set of symbols and the CSI-RS resource associated with FD set of symbols based at least in part on the one of the CSI-IM resource associated with the FD set of symbols or the CSI-RS resource associated with the FD set of symbols overlapping with the at least one HD symbol.

In a thirteenth aspect, alone or in combination with one or more of the first through twelfth aspects, the one or more CSI report configurations further configure one or more CSI-RS resources, the one or more CSI-RS resources including a CSI-RS resource associated with the FD set of symbols, one of the CSI-IM resource associated with the FD set of symbols or the CSI-RS resource associated with the FD set of symbols overlaps with at least one HD symbol, and process 900 includes omitting, from the one or more CSI reports, measurements associated with the one of the CSI-IM resource associated with the FD set of symbols or the CSI-RS resource associated with the FD set of symbols that overlaps with the at least one HD symbol based at least in part on the one of the CSI-IM resource associated with the FD set of symbols or the CSI-RS resource associated with the FD set of symbols overlapping with the at least one HD symbol.

In a fourteenth aspect, alone or in combination with one or more of the first through thirteenth aspects, the CSI-IM resource associated with the FD set of symbols and the CSI-IM resource associated with the HD set of symbols are associated with a same resource, and the same resource spans HD symbols in a slot and FD symbols in the slot.

In a fifteenth aspect, alone or in combination with one or more of the first through fourteenth aspects, performing the interference measurements associated with the at least one of the FD set of symbols or the HD set of symbols includes performing interference measurements associated with FD set of symbols and the HD set of symbols using the same resource.

In a sixteenth aspect, alone or in combination with one or more of the first through fifteenth aspects, the CSI-IM resource associated with the FD set of symbols is associated with a first set of symbols in a slot, and the CSI-IM resource associated with the HD set of symbols is associated with a second set of symbols in the slot.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with CSI-IM resources for FD sets of symbols.

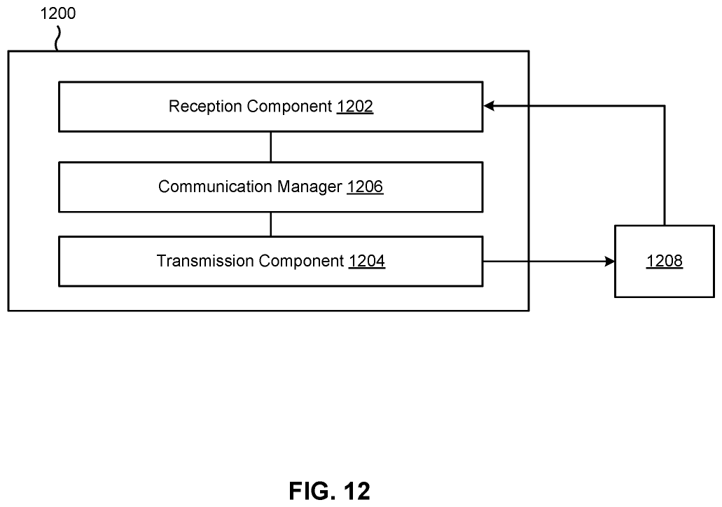

As shown in FIG. 10, in some aspects, process 1000 may include transmitting, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols (block 1010). For example, the network node (e.g., using transmission component 1204 and/or communication manager 1206, depicted in FIG. 12) may transmit, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols, as described above.

As further shown in FIG. 10, in some aspects, process 1000 may include receiving, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols (block 1020). For example, the network node (e.g., using reception component 1202 and/or communication manager 1206, depicted in FIG. 12) may receive, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols, as described above.

Process 1000 may include additional aspects, such as any single aspect or any combination of aspects described below and/or in connection with one or more other processes described elsewhere herein.

In a first aspect, the one or more CSI report configurations include a first CSI report configuration associated with the FD set of symbols and a second CSI report configuration associated with the HD set of symbols, and the one or more CSI reports include a first CSI report reporting interference measurements associated with the FD set of symbols and a second CSI report reporting interference measurements associated with the HD set of symbols.

In a second aspect, alone or in combination with the first aspect, the CSI-IM resource associated with the FD set of symbols is a different resource than the CSI-IM resource associated with the HD set of symbols.

In a third aspect, alone or in combination with one or more of the first and second aspects, the CSI-IM resource associated with the FD set of symbols is associated with a first occasion of a periodic or semi-persistent resource, and the CSI-IM resource associated with the HD set of symbols is associated with a second occasion of the periodic or semi-persistent resource.

In a fourth aspect, alone or in combination with one or more of the first through third aspects, the one or more CSI report configurations include a single CSI report configuration, and the one or more CSI reports include a single CSI report reporting interference measurements associated with the FD set of symbols and interference measurements associated with the HD set of symbols.

In a fifth aspect, alone or in combination with one or more of the first through fourth aspects, the CSI-IM resource associated with the FD set of symbols is a different resource than the CSI-IM resource associated with the HD set of symbols.

In a sixth aspect, alone or in combination with one or more of the first through fifth aspects, the CSI-IM resource associated with the FD set of symbols is associated with a first occasion of a periodic or semi-persistent resource, and the CSI-IM resource associated with the HD set of symbols is associated with a second occasion of the periodic or semi-persistent resource.

In a seventh aspect, alone or in combination with one or more of the first through sixth aspects, at least one of: the CSI-IM resource associated with the FD set of symbols occurs within a same slot as a CSI-RS resource associated with the FD set of symbols, or the CSI-IM resource associated with the HD set of symbols occurs within a same slot as a CSI-RS resource associated with the HD set of symbols.

In an eighth aspect, alone or in combination with one or more of the first through seventh aspects, at least one of: the CSI-IM resource associated with the FD set of symbols occurs within a first slot and a CSI-RS resource associated with the FD set of symbols occurs within a second slot, or the CSI-IM resource associated with the HD set of symbols occurs within the first slot and a CSI-RS resource associated with the HD set of symbols occurs within the second slot.

In a ninth aspect, alone or in combination with one or more of the first through eighth aspects, the first slot and the second slot are separated by no more than a maximum permissible number of slots.

In a tenth aspect, alone or in combination with one or more of the first through ninth aspects, the one or more CSI report configurations further configure one or more CSI-RS resources, the one or more CSI-RS resources including a CSI-RS resource associated with the HD set of symbols, one of the CSI-IM resource associated with the HD set of symbols or the CSI-RS resource associated with the HD set of symbols overlaps with at least one FD symbol, and the one or more CSI reports do not include measurements associated with the CSI-IM resource associated with the HD set of symbols and the CSI-RS resource associated with HD set of symbols based at least in part on the one of the CSI-IM resource associated with the HD set of symbols or the CSI-RS resource associated with the HD set of symbols overlapping with the at least one FD symbol.

In an eleventh aspect, alone or in combination with one or more of the first through tenth aspects, the one or more CSI report configurations further configure one or more CSI-RS resources, the one or more CSI-RS resources including a CSI-RS resource associated with the HD set of symbols, one of the CSI-IM resource associated with the HD set of symbols or the CSI-RS resource associated with the HD set of symbols overlaps with at least one FD symbol, and the one or more CSI reports do not include measurements associated with the one of the CSI-IM resource associated with the HD set of symbols or the CSI-RS resource associated with the HD set of symbols that overlaps with the at least one FD symbol based at least in part on the one of the CSI-IM resource associated with the HD set of symbols or the CSI-RS resource associated with the HD set of symbols overlapping with the at least one FD symbol.

In a twelfth aspect, alone or in combination with one or more of the first through eleventh aspects, the one or more CSI report configurations further configure one or more CSI-RS resources, the one or more CSI-RS resources including a CSI-RS resource associated with the FD set of symbols, one of the CSI-IM resource associated with the FD set of symbols or the CSI-RS resource associated with the FD set of symbols overlaps with at least one HD symbol, and the one or more CSI reports do not include measurements associated with the CSI-IM resource associated with the FD set of symbols and the CSI-RS resource associated with FD set of symbols based at least in part on the one of the CSI-IM resource associated with the FD set of symbols or the CSI-RS resource associated with the FD set of symbols overlapping with the at least one HD symbol.

In a thirteenth aspect, alone or in combination with one or more of the first through twelfth aspects, the one or more CSI report configurations further configure one or more CSI-RS resources, the one or more CSI-RS resources including a CSI-RS resource associated with the FD set of symbols, one of the CSI-IM resource associated with the FD set of symbols or the CSI-RS resource associated with the FD set of symbols overlaps with at least one HD symbol, and the one or more CSI reports do not include measurements associated with the one of the CSI-IM resource associated with the FD set of symbols or the CSI-RS resource associated with the FD set of symbols that overlaps with the at least one HD symbol based at least in part on the one of the CSI-IM resource associated with the FD set of symbols or the CSI-RS resource associated with the FD set of symbols overlapping with the at least one HD symbol.

In a fourteenth aspect, alone or in combination with one or more of the first through thirteenth aspects, the CSI-IM resource associated with the FD set of symbols and the CSI-IM resource associated with the HD set of symbols are associated with a same resource, and the same resource spans HD symbols in a slot and FD symbols in the slot.

In a fifteenth aspect, alone or in combination with one or more of the first through fourteenth aspects, the interference measurements associated with the at least one of the FD set of symbols or the HD set of symbols are associated with the same resource.

In a sixteenth aspect, alone or in combination with one or more of the first through fifteenth aspects, the CSI-IM resource associated with the FD set of symbols is associated with a first set of symbols in a slot, and the CSI-IM resource associated with the HD set of symbols is associated with a second set of symbols in the slot.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE 120 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE 120 described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE 120 described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive configuration information indicating one or more CSI report configurations that configure one or more CSI-IM resources, the one or more CSI-IM resources including a CSI-IM resource associated with an FD set of symbols and a CSI-IM resource associated with an HD set of symbols. The communication manager 1106 may perform interference measurements associated with at least one of the FD set of symbols, using the CSI-IM resource associated with the FD set of symbols, or the HD set of symbols, using the CSI-IM resource associated with the HD set of symbols. The transmission component 1104 may transmit one or more CSI reports reporting the interference measurements associated with the at least one of the FD set of symbols or the HD set of symbols.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node 110 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node 110 described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node 110 described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols. The reception component 1202 may receive, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving configuration information indicating one or more CSI report configurations that configure one or more CSI-IM resources, the one or more CSI-IM resources including a CSI-IM resource associated with an FD set of symbols and a CSI-IM resource associated with an HD set of symbols; performing interference measurements associated with at least one of the FD set of symbols, using the CSI-IM resource associated with the FD set of symbols, or the HD set of symbols, using the CSI-IM resource associated with the HD set of symbols; and transmitting one or more CSI reports reporting the interference measurements associated with the at least one of the FD set of symbols or the HD set of symbols.

Aspect 2: The method of Aspect 1, wherein the one or more CSI report configurations include a first CSI report configuration associated with the FD set of symbols and a second CSI report configuration associated with the HD set of symbols, and wherein the one or more CSI reports include a first CSI report reporting interference measurements associated with the FD set of symbols and a second CSI report reporting interference measurements associated with the HD set of symbols.

Aspect 3: The method of Aspect 2, wherein the CSI-IM resource associated with the FD set of symbols is a different resource than the CSI-IM resource associated with the HD set of symbols.

Aspect 4: The method of Aspect 2, wherein the CSI-IM resource associated with the FD set of symbols is associated with a first occasion of a periodic or semi-persistent resource, and wherein the CSI-IM resource associated with the HD set of symbols is associated with a second occasion of the periodic or semi-persistent resource.

Aspect 5: The method of any of Aspect 1, wherein the one or more CSI report configurations include a single CSI report configuration, and wherein the one or more CSI reports include a single CSI report reporting interference measurements associated with the FD set of symbols and interference measurements associated with the HD set of symbols.

Aspect 6: The method of Aspect 5, wherein the CSI-IM resource associated with the FD set of symbols is a different resource than the CSI-IM resource associated with the HD set of symbols.

Aspect 7: The method of Aspect 5, wherein the CSI-IM resource associated with the FD set of symbols is associated with a first occasion of a periodic or semi-persistent resource, and wherein the CSI-IM resource associated with the HD set of symbols is associated with a second occasion of the periodic or semi-persistent resource.

Aspect 8: The method of any of Aspects 1-7, wherein at least one of: the CSI-IM resource associated with the FD set of symbols occurs within a same slot as a CSI-RS resource associated with the FD set of symbols, or the CSI-IM resource associated with the HD set of symbols occurs within a same slot as a CSI-RS resource associated with the HD set of symbols.

Aspect 9: The method of any of Aspects 1-8, wherein at least one of: the CSI-IM resource associated with the FD set of symbols occurs within a first slot and a CSI-RS resource associated with the FD set of symbols occurs within a second slot, or the CSI-IM resource associated with the HD set of symbols occurs within the first slot and a CSI-RS resource associated with the HD set of symbols occurs within the second slot.

Aspect 10: The method of Aspect 9, wherein the first slot and the second slot are separated by no more than a maximum permissible number of slots.

Aspect 11: The method of any of Aspects 1-10, wherein the one or more CSI report configurations further configure one or more CSI-RS resources, the one or more CSI-RS resources including a CSI-RS resource associated with the HD set of symbols, wherein one of the CSI-IM resource associated with the HD set of symbols or the CSI-RS resource associated with the HD set of symbols overlaps with at least one FD symbol, and wherein the method further includes omitting, from the one or more CSI reports, measurements associated with the CSI-IM resource associated with the HD set of symbols and the CSI-RS resource associated with HD set of symbols based at least in part on the one of the CSI-IM resource associated with the HD set of symbols or the CSI-RS resource associated with the HD set of symbols overlapping with the at least one FD symbol.

Aspect 12: The method of any of Aspects 1-10, wherein the one or more CSI report configurations further configure one or more CSI-RS resources, the one or more CSI-RS resources including a CSI-RS resource associated with the HD set of symbols, wherein one of the CSI-IM resource associated with the HD set of symbols or the CSI-RS resource associated with the HD set of symbols overlaps with at least one FD symbol, and wherein the method further includes omitting, from the one or more CSI reports, measurements associated with the one of the CSI-IM resource associated with the HD set of symbols or the CSI-RS resource associated with the HD set of symbols that overlaps with the at least one FD symbol based at least in part on the one of the CSI-IM resource associated with the HD set of symbols or the CSI-RS resource associated with the HD set of symbols overlapping with the at least one FD symbol.

Aspect 13: The method of any of Aspects 1-12, wherein the one or more CSI report configurations further configure one or more CSI-RS resources, the one or more CSI-RS resources including a CSI-RS resource associated with the FD set of symbols, wherein one of the CSI-IM resource associated with the FD set of symbols or the CSI-RS resource associated with the FD set of symbols overlaps with at least one HD symbol, and wherein the method further includes omitting, from the one or more CSI reports, measurements associated with the CSI-IM resource associated with the FD set of symbols and the CSI-RS resource associated with FD set of symbols based at least in part on the one of the CSI-IM resource associated with the FD set of symbols or the CSI-RS resource associated with the FD set of symbols overlapping with the at least one HD symbol.

Aspect 14: The method of any of Aspects 1-12, wherein the one or more CSI report configurations further configure one or more CSI-RS resources, the one or more CSI-RS resources including a CSI-RS resource associated with the FD set of symbols, wherein one of the CSI-IM resource associated with the FD set of symbols or the CSI-RS resource associated with the FD set of symbols overlaps with at least one HD symbol, and wherein the method further includes omitting, from the one or more CSI reports, measurements associated with the one of the CSI-IM resource associated with the FD set of symbols or the CSI-RS resource associated with the FD set of symbols that overlaps with the at least one HD symbol based at least in part on the one of the CSI-IM resource associated with the FD set of symbols or the CSI-RS resource associated with the FD set of symbols overlapping with the at least one HD symbol.

Aspect 15: The method of any of Aspects 1-14, wherein the CSI-IM resource associated with the FD set of symbols and the CSI-IM resource associated with the HD set of symbols are associated with a same resource, and wherein the same resource spans HD symbols in a slot and FD symbols in the slot.

Aspect 16: The method of Aspect 15, wherein performing the interference measurements associated with the at least one of the FD set of symbols or the HD set of symbols includes performing interference measurements associated with FD set of symbols and the HD set of symbols using the same resource.

Aspect 17: The method of any of Aspects 1-16, wherein the CSI-IM resource associated with the FD set of symbols is associated with a first set of symbols in a slot, and wherein the CSI-IM resource associated with the HD set of symbols is associated with a second set of symbols in the slot.

Aspect 18: A method of wireless communication performed by a network node, comprising: transmitting, to a UE, configuration information indicating one or more CSI report configurations that configure one or more CSI-IM resources, the one or more CSI-IM resources including a CSI-IM resource associated with an FD set of symbols and a CSI-IM resource associated with an HD set of symbols; and receiving, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols.

Aspect 19: The method of Aspect 18, wherein the one or more CSI report configurations include a first CSI report configuration associated with the FD set of symbols and a second CSI report configuration associated with the HD set of symbols, and wherein the one or more CSI reports include a first CSI report reporting interference measurements associated with the FD set of symbols and a second CSI report reporting interference measurements associated with the HD set of symbols.

Aspect 20: The method of Aspect 19, wherein the CSI-IM resource associated with the FD set of symbols is a different resource than the CSI-IM resource associated with the HD set of symbols.

Aspect 21: The method of Aspect 19, wherein the CSI-IM resource associated with the FD set of symbols is associated with a first occasion of a periodic or semi-persistent resource, and wherein the CSI-IM resource associated with the HD set of symbols is associated with a second occasion of the periodic or semi-persistent resource.

Aspect 22: The method of any of Aspects 18, wherein the one or more CSI report configurations include a single CSI report configuration, and wherein the one or more CSI reports include a single CSI report reporting interference measurements associated with the FD set of symbols and interference measurements associated with the HD set of symbols.

Aspect 23: The method of Aspect 22, wherein the CSI-IM resource associated with the FD set of symbols is a different resource than the CSI-IM resource associated with the HD set of symbols.

Aspect 24: The method of Aspect 22, wherein the CSI-IM resource associated with the FD set of symbols is associated with a first occasion of a periodic or semi-persistent resource, and wherein the CSI-IM resource associated with the HD set of symbols is associated with a second occasion of the periodic or semi-persistent resource.

Aspect 25: The method of any of Aspects 18-24, wherein at least one of: the CSI-IM resource associated with the FD set of symbols occurs within a same slot as a CSI-RS resource associated with the FD set of symbols, or the CSI-IM resource associated with the HD set of symbols occurs within a same slot as a CSI-RS resource associated with the HD set of symbols.

Aspect 26: The method of any of Aspects 18-25, wherein at least one of: the CSI-IM resource associated with the FD set of symbols occurs within a first slot and a CSI-RS resource associated with the FD set of symbols occurs within a second slot, or the CSI-IM resource associated with the HD set of symbols occurs within the first slot and a CSI-RS resource associated with the HD set of symbols occurs within the second slot.

Aspect 27: The method of Aspect 26, wherein the first slot and the second slot are separated by no more than a maximum permissible number of slots.

Aspect 28: The method of any of Aspects 18-27, wherein the one or more CSI report configurations further configure one or more CSI-RS resources, the one or more CSI-RS resources including a CSI-RS resource associated with the HD set of symbols, wherein one of the CSI-IM resource associated with the HD set of symbols or the CSI-RS resource associated with the HD set of symbols overlaps with at least one FD symbol, and wherein the one or more CSI reports do not include measurements associated with the CSI-IM resource associated with the HD set of symbols and the CSI-RS resource associated with HD set of symbols based at least in part on the one of the CSI-IM resource associated with the HD set of symbols or the CSI-RS resource associated with the HD set of symbols overlapping with the at least one FD symbol.

Aspect 29: The method of any of Aspects 18-27, wherein the one or more CSI report configurations further configure one or more CSI-RS resources, the one or more CSI-RS resources including a CSI-RS resource associated with the HD set of symbols, wherein one of the CSI-IM resource associated with the HD set of symbols or the CSI-RS resource associated with the HD set of symbols overlaps with at least one FD symbol, and wherein the one or more CSI reports do not include measurements associated with the one of the CSI-IM resource associated with the HD set of symbols or the CSI-RS resource associated with the HD set of symbols that overlaps with the at least one FD symbol based at least in part on the one of the CSI-IM resource associated with the HD set of symbols or the CSI-RS resource associated with the HD set of symbols overlapping with the at least one FD symbol.

Aspect 30: The method of any of Aspects 18-29, wherein the one or more CSI report configurations further configure one or more CSI-RS resources, the one or more CSI-RS resources including a CSI-RS resource associated with the FD set of symbols, wherein one of the CSI-IM resource associated with the FD set of symbols or the CSI-RS resource associated with the FD set of symbols overlaps with at least one HD symbol, and wherein the one or more CSI reports do not include measurements associated with the CSI-IM resource associated with the FD set of symbols and the CSI-RS resource associated with FD set of symbols based at least in part on the one of the CSI-IM resource associated with the FD set of symbols or the CSI-RS resource associated with the FD set of symbols overlapping with the at least one HD symbol.

Aspect 31: The method of any of Aspects 18-29, wherein the one or more CSI report configurations further configure one or more CSI-RS resources, the one or more CSI-RS resources including a CSI-RS resource associated with the FD set of symbols, wherein one of the CSI-IM resource associated with the FD set of symbols or the CSI-RS resource associated with the FD set of symbols overlaps with at least one HD symbol, and wherein the one or more CSI reports do not include measurements associated with the one of the CSI-IM resource associated with the FD set of symbols or the CSI-RS resource associated with the FD set of symbols that overlaps with the at least one HD symbol based at least in part on the one of the CSI-IM resource associated with the FD set of symbols or the CSI-RS resource associated with the FD set of symbols overlapping with the at least one HD symbol.

Aspect 32: The method of any of Aspects 18-31, wherein the CSI-IM resource associated with the FD set of symbols and the CSI-IM resource associated with the HD set of symbols are associated with a same resource, and wherein the same resource spans HD symbols in a slot and FD symbols in the slot.

Aspect 33: The method of Aspect 32, wherein the interference measurements associated with the at least one of the FD set of symbols or the HD set of symbols are associated with the same resource.

Aspect 34: The method of any of Aspects 18-33, wherein the CSI-IM resource associated with the FD set of symbols is associated with a first set of symbols in a slot, and wherein the CSI-IM resource associated with the HD set of symbols is associated with a second set of symbols in the slot.

Aspect 35: An apparatus for wireless communication at a device, comprising a processor; memory coupled with the processor; and instructions stored in the memory and executable by the processor to cause the apparatus to perform the method of one or more of Aspects 1-34.

Aspect 36: A device for wireless communication, comprising a memory and one or more processors coupled to the memory, the one or more processors configured to perform the method of one or more of Aspects 1-34.

Aspect 37: An apparatus for wireless communication, comprising at least one means for performing the method of one or more of Aspects 1-34.

Aspect 38: A non-transitory computer-readable medium storing code for wireless communication, the code comprising instructions executable by a processor to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive configuration information indicating one or more channel state information (CSI) report configurations that configure one or more CSI interference measurement (CSI-IM) resources, the one or more CSI-IM resources including a CSI-IM resource associated with a full-duplex (FD) set of symbols and a CSI-IM resource associated with a half-duplex (HD) set of symbols;
perform interference measurements associated with at least one of the FD set of symbols, using the CSI-IM resource associated with the FD set of symbols, or the HD set of symbols, using the CSI-IM resource associated with the HD set of symbols; and
transmit one or more CSI reports reporting the interference measurements associated with the at least one of the FD set of symbols or the HD set of symbols.

2. The UE of claim 1, wherein the one or more CSI report configurations include a first CSI report configuration associated with the FD set of symbols and a second CSI report configuration associated with the HD set of symbols, and
wherein the one or more CSI reports include a first CSI report reporting interference measurements associated with the FD set of symbols and a second CSI report reporting interference measurements associated with the HD set of symbols.

3. The UE of claim 2, wherein the CSI-IM resource associated with the FD set of symbols is a different resource than the CSI-IM resource associated with the HD set of symbols.

4. The UE of claim 2, wherein the CSI-IM resource associated with the FD set of symbols is associated with a first occasion of a periodic or semi-persistent resource, and
wherein the CSI-IM resource associated with the HD set of symbols is associated with a second occasion of the periodic or semi-persistent resource.

5. The UE of claim 1, wherein the one or more CSI report configurations include a single CSI report configuration, and
wherein the one or more CSI reports include a single CSI report reporting interference measurements associated with the FD set of symbols and interference measurements associated with the HD set of symbols.

6. The UE of claim 5, wherein the CSI-IM resource associated with the FD set of symbols is a different resource than the CSI-IM resource associated with the HD set of symbols.

7. The UE of claim 5, wherein the CSI-IM resource associated with the FD set of symbols is associated with a first occasion of a periodic or semi-persistent resource, and
wherein the CSI-IM resource associated with the HD set of symbols is associated with a second occasion of the periodic or semi-persistent resource.

8. The UE of claim 1, wherein at least one of:
the CSI-IM resource associated with the FD set of symbols occurs within a same slot as a CSI reference signal (CSI-RS) resource associated with the FD set of symbols, or
the CSI-IM resource associated with the HD set of symbols occurs within a same slot as a CSI-RS resource associated with the HD set of symbols.

9. The UE of claim 1, wherein at least one of:
the CSI-IM resource associated with the FD set of symbols occurs within a first slot and a CSI reference signal (CSI-RS) resource associated with the FD set of symbols occurs within a second slot, or
the CSI-IM resource associated with the HD set of symbols occurs within the first slot and a CSI-RS resource associated with the HD set of symbols occurs within the second slot.

10. The UE of claim 9, wherein the first slot and the second slot are separated by no more than a maximum permissible number of slots.

11. The UE of claim 1, wherein the one or more CSI report configurations further configure one or more CSI reference signal (CSI-RS) resources, the one or more CSI-RS resources including a CSI-RS resource associated with the HD set of symbols,
wherein one of the CSI-IM resource associated with the HD set of symbols or the CSI-RS resource associated with the HD set of symbols overlaps with at least one FD symbol, and
wherein the one or more processors are further configured to omit, from the one or more CSI reports, measurements associated with the CSI-IM resource associated with the HD set of symbols and the CSI-RS resource associated with HD set of symbols based at least in part on the one of the CSI-IM resource associated with the HD set of symbols or the CSI-RS resource associated with the HD set of symbols overlapping with the at least one FD symbol.

12. The UE of claim 1, wherein the one or more CSI report configurations further configure one or more CSI reference signal (CSI-RS) resources, the one or more CSI-RS resources including a CSI-RS resource associated with the HD set of symbols,
wherein one of the CSI-IM resource associated with the HD set of symbols or the CSI-RS resource associated with the HD set of symbols overlaps with at least one FD symbol, and
wherein the one or more processors are further configured to omit, from the one or more CSI reports, measurements associated with the one of the CSI-IM resource associated with the HD set of symbols or the CSI-RS resource associated with the HD set of symbols that overlaps with the at least one FD symbol based at least in part on the one of the CSI-IM resource associated with the HD set of symbols or the CSI-RS resource associated with the HD set of symbols overlapping with the at least one FD symbol.

13. The UE of claim 1, wherein the one or more CSI report configurations further configure one or more CSI reference signal (CSI-RS) resources, the one or more CSI-RS resources including a CSI-RS resource associated with the FD set of symbols,
wherein one of the CSI-IM resource associated with the FD set of symbols or the CSI-RS resource associated with the FD set of symbols overlaps with at least one HD symbol, and
wherein the one or more processors are further configured to omit, from the one or more CSI reports, measurements associated with the CSI-IM resource associated with the FD set of symbols and the CSI-RS resource associated with FD set of symbols based at least in part on the one of the CSI-IM resource associated with the FD set of symbols or the CSI-RS resource associated with the FD set of symbols overlapping with the at least one HD symbol.

14. The UE of claim 1, wherein the one or more CSI report configurations further configure one or more CSI reference signal (CSI-RS) resources, the one or more CSI-RS resources including a CSI-RS resource associated with the FD set of symbols,
wherein one of the CSI-IM resource associated with the FD set of symbols or the CSI-RS resource associated with the FD set of symbols overlaps with at least one HD symbol, and
wherein the one or more processors are further configured to omit, from the one or more CSI reports, measurements associated with the one of the CSI-IM resource associated with the FD set of symbols or the CSI-RS resource associated with the FD set of symbols that overlaps with the at least one HD symbol based at least in part on the one of the CSI-IM resource associated with the FD set of symbols or the CSI-RS resource associated with the FD set of symbols overlapping with the at least one HD symbol.

15. The UE of claim 1, wherein the CSI-IM resource associated with the FD set of symbols and the CSI-IM resource associated with the HD set of symbols are associated with a same resource, and
wherein the same resource spans HD symbols in a slot and FD symbols in the slot.

16. The UE of claim 15, wherein the one or more processors, to perform the interference measurements associated with the at least one of the FD set of symbols or the HD set of symbols, are configured to perform interference measurements associated with FD set of symbols and the HD set of symbols using the same resource.

17. The UE of claim 1, wherein the CSI-IM resource associated with the FD set of symbols is associated with a first set of symbols in a slot, and wherein the CSI-IM resource associated with the HD set of symbols is associated with a second set of symbols in the slot.

18. A network node for wireless communication, comprising:
one or more memories; and
one or more processors, coupled to the one or more memories, configured to:
transmit, to a user equipment (UE), configuration information indicating one or more channel state information (CSI) report configurations that configure one or more CSI interference measurement (CSI-IM) resources, the one or more CSI-IM resources including a CSI-IM resource associated with a full-duplex (FD) set of symbols and a CSI-IM resource associated with a half-duplex (HD) set of symbols; and
receive, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols.

19. The network node of claim 18, wherein the one or more CSI report configurations include a first CSI report configuration associated with the FD set of symbols and a second CSI report configuration associated with the HD set of symbols, and
wherein the one or more CSI reports include a first CSI report reporting interference measurements associated with the FD set of symbols and a second CSI report reporting interference measurements associated with the HD set of symbols.

20. The network node of claim 19, wherein the CSI-IM resource associated with the FD set of symbols is a different resource than the CSI-IM resource associated with the HD set of symbols.

21. The network node of claim 19, wherein the CSI-IM resource associated with the FD set of symbols is associated with a first occasion of a periodic or semi-persistent resource, and
wherein the CSI-IM resource associated with the HD set of symbols is associated with a second occasion of the periodic or semi-persistent resource.

22. The network node of claim 18, wherein the one or more CSI report configurations include a single CSI report configuration, and
wherein the one or more CSI reports include a single CSI report reporting interference measurements associated with the FD set of symbols and interference measurements associated with the HD set of symbols.

23. The network node of claim 22, wherein the CSI-IM resource associated with the FD set of symbols is a different resource than the CSI-IM resource associated with the HD set of symbols.

24. The network node of claim 22, wherein the CSI-IM resource associated with the FD set of symbols is associated with a first occasion of a periodic or semi-persistent resource, and
wherein the CSI-IM resource associated with the HD set of symbols is associated with a second occasion of the periodic or semi-persistent resource.

25. The network node of claim 18, wherein at least one of:
the CSI-IM resource associated with the FD set of symbols occurs within a same slot as a CSI reference signal (CSI-RS) resource associated with the FD set of symbols, or
the CSI-IM resource associated with the HD set of symbols occurs within a same slot as a CSI-RS resource associated with the HD set of symbols.

26. The network node of claim 18, wherein at least one of:
the CSI-IM resource associated with the FD set of symbols occurs within a first slot and a CSI reference signal (CSI-RS) resource associated with the FD set of symbols occurs within a second slot, or
the CSI-IM resource associated with the HD set of symbols occurs within the first slot and a CSI-RS resource associated with the HD set of symbols occurs within the second slot.

27. A method of wireless communication performed by a user equipment (UE), comprising:
receiving configuration information indicating one or more channel state information (CSI) report configurations that configure one or more CSI interference measurement (CSI-IM) resources, the one or more CSI-IM resources including a CSI-IM resource associated with a full-duplex (FD) set of symbols and a CSI-IM resource associated with a half-duplex (HD) set of symbols;
performing interference measurements associated with at least one of the FD set of symbols, using the CSI-IM resource associated with the FD set of symbols, or the HD set of symbols, using the CSI-IM resource associated with the HD set of symbols; and
transmitting one or more CSI reports reporting the interference measurements associated with the at least one of the FD set of symbols or the HD set of symbols.

28. The method of claim 27, wherein the one or more CSI report configurations include a first CSI report configuration associated with the FD set of symbols and a second CSI report configuration associated with the HD set of symbols, and wherein the one or more CSI reports include a first CSI report reporting interference measurements associated with the FD set of symbols and a second CSI report reporting interference measurements associated with the HD set of symbols.

29. A method of wireless communication performed by a network node, comprising:
transmitting, to a user equipment (UE), configuration information indicating one or more channel state information (CSI) report configurations that configure one or more CSI interference measurement (CSI-IM) resources, the one or more CSI-IM resources including a CSI-IM resource associated with a full-duplex (FD) set of symbols and a CSI-IM resource associated with a half-duplex (HD) set of symbols; and
receiving, from the UE, one or more CSI reports reporting interference measurements associated with at least one of the FD set of symbols, based at least in part on the CSI-IM resource associated with the FD set of symbols, or the HD set of symbols, based at least in part on the CSI-IM resource associated with the HD set of symbols.

30. The method of claim 29, wherein the one or more CSI report configurations include a single CSI report configuration, and
wherein the one or more CSI reports include a single CSI report reporting interference measurements associated with the FD set of symbols and interference measurements associated with the HD set of symbols.
